(19) United States
(12) Patent Application Publication
(10) Pub. No.: US 2024/0327657 A1
(43) Pub. Date: Oct. 3, 2024

(54) SILKY-WHITE MULTILAYER COATING

(71) Applicant: BASF COATINGS GMBH, Muenster (DE)

(72) Inventors: Zenon Paul CZORNIJ, Brighton, MI (US); Phyllis A. WEAKS, Troy, MI (US); Daniel W. JOHNSON, Southfield, MI (US); Zhongliang ZHU, Troy, MI (US); Qingling ZHANG, Southfield, MI (US)

(21) Appl. No.: 18/579,195

(22) PCT Filed: Aug. 30, 2022
(86) PCT No.: PCT/EP22/74120

§ 371 Date: Jan. 12, 2024

(30) Foreign Application Priority Data
Aug. 30, 2021 (EP) 21193783.4

(51) Int. Cl. C09D 5/36; B05D 7/00; B05D 7/14; C09D 7/40; C09D 7/61

(52) U.S. Cl. CPC C09D 5/36; B05D 7/14; B05D 7/572; C09D 7/61; C09D 7/70; B05D 2202/00; B05D 2350/60; B05D 2601/06; B05D 2601/08

(57) ABSTRACT

Disclosed herein is a multilayer coating including at least one ground coat layer, the at least one ground coat layer including at least one non-platelet-shaped titanium dioxide pigment (T); at least one midcoat layer on top of the at least one ground coat layer, and at least one clearcoat layer on top of the at least one midcoat layer; and having a lightness L* according to CIELab in the viewing angle range from −15° to +45° of at least 80; in the viewing angle range from +75° to +110° of at least 70, if a metal effect pigment is contained in the midcoat layer; in the viewing angle range from +75° to +110° of at least 75, if no metal effect pigment is contained in the midcoat layer. Further disclosed herein are a method for producing such multilayer coating and a multilayer coated substrate.

The present invention relates to multilayer coatings, a method for producing such multilayer coatings and thus coated substrates. The multilayer coatings are preferably for coating vehicles and vehicle parts such as automotive bodies and their parts.

### TECHNOLOGICAL BACKGROUND

In recent years, the color white has become the most important color in the automotive industry in terms of number of vehicles sold. White colors may be subdivided into two main categories, those with platelet-shaped effect pigments and those without.

The first category is often called “metallic” or “pearlescent” whites but may contain numerous platelets of varying compositions. These compositions may be based on different substrates such as metals, natural or synthetic mica, glass, oxides of metals, silicates and others. The platelets may be coated, e.g., with (semi) metal oxide layers to produce so-called “silky white” effects.

However, these multilayer coatings often display a coarse texture and it is usual to discern a multicolored rainbow interference arising from the coated platelets. Other problems associated with the use of such platelet-shaped pigments are that fine, silky effects are challenging to obtain, or the color does not maintain a bright, pure white color.

The most commonly used white colorants in the field of automotive coatings are based on titanium dioxide. Thus, there is ongoing and even increasing desire to provide unique titanium oxide and titanium dioxide-based effect-providing formulations that can be used in the manufacture of automotive coatings.

Oftentimes, the generally used titanium dioxide pigments offer no travel, and provide the same or similar brightness value across the whole viewing angle range. Other products tend to reduce the pure white look in a white coating by having a characteristic interference “rainbow” effect as explained above or by reducing the brightness of the color or adding non-desirable hue.

An influence on the color is the compositional nature of titanium oxide and titanium dioxide-based effect pigments. A large particle size distribution increases the light scattering along the edges of such flaky pigments, arising in an apparent coarse look. Furthermore, the effect pigments generate a display of multiple colors that is evident on close inspection of the coating surface giving rise to a “rainbow” reflection of the effect pigments.

The present invention aims to provide a multilayer coating that has a slight metallic look, a bright white color and shows a fine, silky and soft metallic texture effect, while maintaining excellent lightness L* values without excessive graininess.

### SUMMARY

The above aims were achieved by providing a multilayer coating, comprising
a) at least one ground coat layer, the at least one ground coat layer comprising at least one non-platelet-shaped titanium dioxide pigment (T);
b) at least one midcoat layer on top of the at least one ground coat layer, the midcoat layer comprising
   i. at least one platelet-shaped titanium oxide pigment (P) selected from the group consisting of hydrogen titanium oxide (P1), titanium dioxide coated fluorinated mica (P2) and titanium dioxide coated aluminum (P3); and
c) at least one clearcoat layer on top of the at least one midcoat layer; and having a lightness L* according to CIELab
in the viewing angle range from −15° to +45° of at least 80;
in the viewing angle range from +75° to +110° of at least 70, if titanium dioxide coated aluminum (P3) is contained in the midcoat layer; and
in the viewing angle range from +75° to +110° of at least 75, if titanium dioxide coated aluminum (P3) is not contained in the midcoat layer.

The afore-mentioned multilayer coating and its preferred embodiments are hereinafter denoted as multilayer coatings according to the invention.

It is also possible to describe the multilayer coatings provided by the present invention in terms of their coloristic properties. Thus, the present invention provides a multilayer coating, comprising at least one ground coat layer, at least one midcoat layer and at least one clearcoat layer and having
a lightness L* according to CIELab
   (i) in the viewing angle range from −15° to +45° of at least 80;
   (ii) in the viewing angle range from +75° to +110° of at least 70, if a metal effect pigment is contained in the midcoat layer;
   (iii) in the viewing angle range from +75° to +110° of at least 75, if no metal effect pigment is contained in the midcoat layer; and
   (iv) at the viewing angle of +15° of at least 105;
a graininess G_{diff} of ≤2.5; and
a liquid metal index LMI of ≥0.9.

The afore-mentioned multilayer coating and its preferred embodiments are also hereinafter denoted as multilayer coatings according to the invention.

A further object of the present invention is a method for producing the multilayer coating, the method comprising
a. applying at least one ground coat composition on a coated or uncoated substrate to form one or more ground coat layer(s), the ground coat composition(s) comprising at least one non-platelet-shaped titanium dioxide pigment (T);
b. applying on the thus formed only or last ground coat layer(s) at least one midcoat composition to form one or more midcoat layer(s), the midcoat composition(s) comprising at least one platelet-shaped titanium oxide pigment (P) selected from the group consisting of hydrogen titanium oxide (P1), titanium dioxide coated fluorinated mica (P2) and titanium dioxide coated aluminum (P3); and
c. applying on the thus formed only or last midcoat layer(s) at least one clearcoat composition to form one or more clearcoat layer(s); and
d. curing the not yet cured or not yet fully cured ground coat layers, midcoat layers and/or clearcoat layers.

The afore-mentioned method of producing a multilayer coating and its preferred embodiments is hereinafter denoted as method of producing multilayer coatings according to the invention.

Yet another object of the present invention is a multilayer coated substrate, which is coated with the multilayer coating according to the invention, being denoted herein-after as the multilayer coated substrate of the present invention.

### DETAILED DESCRIPTION

Hereinafter, preferred embodiments and features of the invention will be described in more detail.

The term “comprising” in the general context of the present invention and particularly in connection with the coating layers and coating compositions according to the invention has the meaning of “containing” rather than “consisting of”. Particularly, “comprising” means that in addition to layers or components or compounds, listed in the respective context, one or more further layers, components or compounds mentioned hereinafter may optionally be contained in the multilayer coating or coating compositions according to the invention. All components can be present in each case in accordance with their preferred embodiments mentioned below.

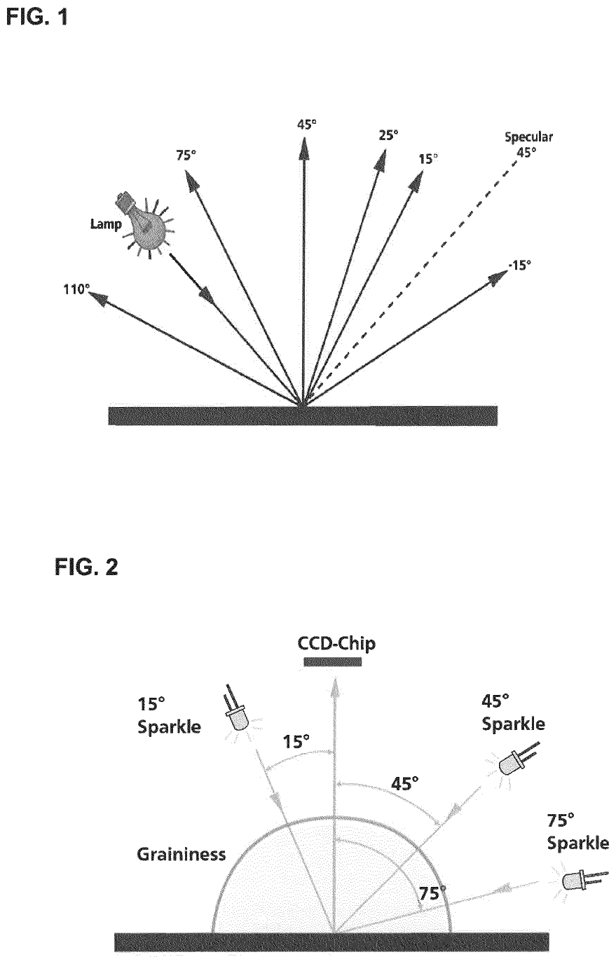

The term “viewing angle range” herein defines distinctive angles in the range from −15° to +110°, namely those angles at which the L*, a* and b* values are determined by the commonly used measurement set-up. In such set-up, the distinctive viewing angles are at −15°, +15°, +25°, +45°, +75° and +110° off-specular as show in FIG. 1. Thus, e.g., the determination of an L* value in the viewing angle range from −15° to +45° means that the L* value at a viewing angle of −15°, +15°, +25° and +45° is determined and relevant.

The proportions and amounts in wt.-% (i.e., % by weight) of all mandatory components of the coating compositions and further optionally present components add up to 100 wt.-%, based on the total weight of the respective coating composition.

The preparation of any of the coating compositions described below can be carried out using customary and known preparation and mixing methods and mixing units and/or using conventional dissolvers and/or stirrers.

Multilayer Coatings, the Different Layers therein and their Compositions

The multilayer coatings of the present invention comprise or consist of at least three layers, namely at least one ground coat layer, at least one midcoat layer (hereinafter also called “basecoat layer”) and at least one clearcoat layer. Preferably the multilayer coatings of the present invention comprise or consist of one ground coat layer, one or two, preferably one basecoat layer and one clearcoat layer.

The ground coat layer(s), midcoat layer(s) and clearcoat layer(s) are formed by applying ground coat composition(s) onto a precoated or uncoated substrate, midcoat composition(s) onto the only or last ground coat layer and clearcoat composition(s) onto the only or last midcoat layer, respectively. If several spray passes with the same coating composition are used to apply a respective layer, this is considered as formation of one layer. Only if two or more different ground coat, midcoat or clearcoat compositions are used, this is considered to form two or more ground coat, midcoat or clearcoat layers, respectively.

The multilayer coatings of the present invention are white, i.e., they create a color impression within the white color space as defined by the L* values above. More preferably, the white color space is characterized in addition to the above mandatory L* values by the following CIELab values a* and b* (according to EN ISO 11664-4 “Colorimetry—Part 4: CIE 1976 L*a*b* Colour Space”, edition July 2011; herein this standard is just referred to as CIELab): a* being from −3.8 to +3.8 and b* being from −5 to +4 in the viewing angle range from −15 to +110°. The aforementioned ranges allow a slight tinting of the multilayer coatings, especially preferably a tinting of the ground coat layer of the multilayer coating, still maintaining the white color impression that is created for the observers.

The inventive multilayer coatings preferably possess
a lightness (L*) value being ≥105, more preferred ≥108 and most preferred ≥110 or even ≥115 at a +15° viewing angle, and/or
a lightness (L*) value of ≥75, more preferred ≥78, most preferred ≥80 or even ≥85 at a +110° viewing angle, and/or
a graininess (G_{diff}) value being ≤2.5, more preferred ≤2.2, most preferred ≤2.0 or even ≤1.8, and/or
a liquid metal index (LMI) value being ≥0.9, more preferred ≥1.0, most preferred ≥1.20.

The afore-mentioned preferred properties L* (at 15° and) 110°, G_{diff} and LMI are independently of each other suitable to further characterize and improve the multilayer coatings of the present invention and can independently be put into practice. Thus, the broadest embodiment of the invention can be further improved by increasing the lightness at a +15° viewing angle or at a +110° viewing angle or by increasing the liquid metal index or by decreasing the graininess or by improving two, three or all four properties. Particularly preferred is that the multilayer coatings have a graininess value ≤2.5, which can, e.g., be put into practice as disclosed herein below.

Furthermore, it is preferred that the white multilayer coatings be hue neutral to slightly bluish i.e., it is preferred that the b* value of the inventive multilayer coating is preferably ≤3, more preferred ≤1, most preferred ≤0 and even ≤−0.5 across the viewing angles from −15° to 110°. In all cases the lower limit of b* preferably being −5 across viewing angles from −15° to 110°.

Preferably the multilayer coatings of the present invention possess a sparkle area at 15° viewing angle in the range from 4 to 16, more preferably in the range from 5 to 15 and most preferable in the range from 6 to 12; and possess a sparkle intensity at 15° viewing angle in the range from 2 to 8, more preferably in the range from 2.5 to 7 and most preferable in the range from 3 to 6.

The L*, a*, b*, sparkle area and intensity, graininess, flop index and liquid metal index values being determined with a BYK Mac i spectrophotometer as described in detail in the experimental section of the present invention.

The solids content of a coating composition or part of it is determined by drying a sample of the coating composition or part of it (approx. 1 g) for 60 min at 110° C. The weight of the dry residue divided by the weight of the sample and multiplied by 100 is the solids content in wt.-%.

In the following, first, the different types of layers and the respective coating compositions used to form the layers, will be described.

### Ground Coat Layer and Ground Coat Composition

The ground coat layer or ground coat layers are characterized in that at least one ground coat layer comprises at least one non-platelet-shaped titanium dioxide pigment (T). This layer imparts a good hiding power, so that the underlying uncoated or precoated substrate color is preferably not visible.

The titanium dioxide pigment (T) as used in this ground coat layer is typically a conventional titanium dioxide pigment as used in the automotive coatings industry. Such non-platelet-shaped titanium dioxide pigments (T) are typically spherical or irregular shaped and of the rutile type, preferably obtained by the well-known chloride process. They comprise primary particles, agglomerates and aggregates and are typically grinded/milled to form pigment pastes, which are employed in the ground coat composition used to form the ground coat layer.

Titanium dioxide pigments (T) may comprise slight amount of other metal oxides such as alumina or semi-metal oxides, such as silicon dioxide. In such cases the titanium dioxide pigment typically serves as core particle and the different metal oxides and semi-metal oxides are precipitated on the pigment surface to employ properties such as a better wettability and the like. However, the titanium dioxide content of such pigments is preferably at least 90 wt.-%, more preferable at least more than 92 wt.-% based on the total pigment weight.

Such titanium dioxide (T), as employed in the manufacture of the ground coat compositions, preferably have a median primary particle size in the range from 200 to 500 nm, more preferred from 300 to 400 nm as determined by dynamic light scattering using a Malvern Zetasizer (from Malvern, S90 unit, Nanoseries Model ZEN 1690 mfg May 2017). This method is also used throughout the description for determination of Z-average particle sizes, and to determine volume-based D₁₀, D₅₀ and D₉₀ values. More details are found in the experimental part of the description.

Such titanium dioxide pigments (T) are commercially available e.g., under the tradename Ti-Pure™ from Chemour, Kronos 2310 from Kronos, CR510 from Citic Titanium, or Tiona 596 from Cristal.

The preferred dry-layer thickness of the ground coat layer or stack of ground coat layers ranges from 8 to 20 μm, more preferred from 12 to 18 μm.

The dry-layer thickness of any coating layer of the multilayer coating of the invention can be determined as explained in the experimental section of the present invention.

The ground coat layer(s) are formed by application of ground coat compositions, which contain one or more of the above-mentioned non-platelet-shaped titanium dioxide pigments onto an uncoated or precoated substrate.

The ground coat compositions are typically selected from one-pack compositions and two-pack compositions, which can be aqueous or solvent-based.

Hereinafter, valid for any coating composition (ground coat composition, midcoat composition and clearcoat composition), a coating composition is classified as being an aqueous or waterborne coating compositions, if the main volatile content is water, in those cases, where the main volatile content is an organic solvent or a mixture of organic solvents, the coating composition is herein classified as being a solvent-based or solventborne coating composition. The volatile content is the difference between the total weight of the coating composition and its solids content. Suitable solvents for solventborne coating compositions are described hereinafter under the headline “solvents(S) for use in the ground coat, midcoat and clearcoat composition”.

Herein preferred is the use of aqueous one-pack compositions as ground coat compositions.

Preferably, the solids content of aqueous ground coat compositions according to the invention is in a range from 25 to 55 wt.-%, more preferably from 27 to 50 wt.-%, most preferably from 35 to 45 wt.-%, in particular from 37 to 42 wt.-%.

Preferably, the solids content of solventborne ground coat compositions according to the invention is in a range from 30 to 80 wt.-%, more preferably from 40 to 70 wt.-%, most preferably from 50 to 68 wt.-%, in particular from 55 to 66 wt.-%.

Besides the afore-mentioned non-platelet-shaped titanium dioxide pigments (T) the ground coat compositions comprise at least one film-forming polymer (A1), if (A1) is externally crosslinkable, a crosslinking agent (A2), optionally one or more dyes (B1), pigments (B2) and/or fillers (B3), which differ from the non-platelet-shaped titanium dioxide pigments (T), a solvent component(S) and further optional components (C) such as typical coatings additives, such as rheology additives and the like. Since these afore-mentioned components of the ground coat composition might also be used in one or more of the other coating compositions (midcoat compositions and clearcoat compositions), they are further described in a separate part of the description below.

### Midcoat Layer and Midcoat Composition

The terms “midcoat layer” and “midcoat composition” are known in the art and often also referred to as “basecoat layer” and “basecoat compositions”, respectively. The term “basecoat” is, e.g., defined in Rompp Lexikon, “Lacke und Druckfarben” (“Paints and “Printing Inks”), Georg Thieme Verlag, 1998, 10th edition, page 57. A basecoat or midcoat as named herein is therefore in particular used in automotive coating and general industrial paint coloring in order to give a coloring and/or an optical effect by using the basecoat/midcoat composition as an intermediate coating composition. Basecoat/midcoat compositions are generally applied to a metal or plastic substrate, optionally pretreated and/or precoated with a ground coat composition, in the present application at least onto a ground coat layer.

The midcoat layer or layers of the present invention are formed by applying one or more midcoat compositions onto the only or last ground coat layer. The midcoat layer or layers of the present invention comprise at least one platelet-shaped titanium oxide pigment (P) selected from the group consisting of hydrogen titanium oxide (P1), titanium dioxide coated fluorinated mica (P2) and titanium dioxide coated aluminum (P3).

### Platelet-Shaped Titanium Oxide Pigments (P)

The term “platelet-shaped” is a commonly used term in the art of coatings and refers to the platelet-like shape of effects pigments as used in DIN EN ISO 4618:215-01 for characterizing the term “effect pigment”. Such pigments typically have a high aspect ratio (average particle length/average particle thickness). Platelet-shaped pigments as used in the present invention are preferably flake-shaped pigments.

All the following three types of pigments (P1), (P2) and (P3) are preferably apt to provide a blue color shift (“travel”) at different angles, while increasing brightness at near specular viewing angles (+15°). In principle, the inventors found that larger pigment sizes add to more brightness, while the smaller sized pigments reduce the grain.

### Hydrogen Titanium Oxide (P1)

Platelet-shaped, particularly flake-shaped hydrogen titanium oxide pigments (P1) and their production are, e.g., described in EP 2 007 598 A1 and EP 3 753 903 A1, as flaky titanic acid, in US 2021/0047517 or in Chem. Mater. 2018, 30, 1505-1516. With respect to these products, it is often referred to the formulae H₂Ti₃O₇ or H_{4x/3}Ti_{2-x/3}O₄·nH₂O, wherein x is 0.50 to 1.0, and n is 0 to 2. The product may contain bound crystal water, which, if present, is considered to be part of the pigment.

Such hydrogen titanium oxide pigments (P1), as employed in the manufacture of the midcoat compositions, preferably have a volume-based D₅₀ average particle size in the range from 5 to 50 μm, more preferred from 8 to 40 μm and most preferred in the range from 10 to 35 μm as determined by dynamic light scattering using the same method and instruments as described above and in the experimental section of the description and preferably a platelet thickness in the range of 50 to 150 nm, more preferred in the range of 70 to 130 nm and most preferred in the range of 90 to 110 nm as determined by electron microscopy as detailed in the experimental part of the description. All platelet thicknesses of any platelet-shaped pigment used in the present invention can be determined by this method.

These hydrogen titanium oxides add to the color change of the multilayer coating in the white color space, simultaneously reducing the rainbow effect as described for the prior art coatings and adds to brightness and a bluish hue at the near off-specular range (−15° and +15°), thus providing a purer white impression at these angles.

These hydrogen titanium oxide pigments (P1) are, e.g., commercially available from Ishikara Sangyo Kaisha, Ltd., e.g., under the name LPT-106.

If present in the midcoat composition, the weight ratio of the hydrogen titanium oxide (P1) to the sum of film-forming polymers (A1) and crosslinkers (A2), i.e., (P1)/[(A1)+(A2)] is preferably in the range from 0.01 to 0.5, more preferred 0.05 to 0.4 and most preferred 0.1 to 0.3.

### Titanium Dioxide Coated Fluorinated Mica (P2)

The term “fluorinated mica” or “fluorine mica” denominates synthetic micas, wherein OH groups are replaced by F groups in the respective mica formula.

The platelet-shaped titanium dioxide coated fluorinated mica (P2) is a titanium dioxide coated synthetic mica and particularly preferred a titanium dioxide coated synthetic fluorphlogopite.

Unlike natural mica, which is mined in the presence of sand, kaolin, feldspar and other silicates and will contain various impurities such as iron oxides and heavy metals, synthetic micas do not contain such impurities. Because of the presence of these additional impurities, natural mica is often discolored. This discoloration is of course, an undesired characteristic of the natural material particularly when the mica is used as a platelet, core or substrate for pigments, particularly in paints of the white color space.

Furthermore, natural mica must be ground to produce flakes. This grinding does not allow for tight control of the smoothness of the mica surface, stepped characteristics and the thinness of the flake. Accordingly, the flakes often have imperfect edges and faces and less specular reflection (edge scattering). Thus, natural mica mining and grinding does not favor the production of large diameter, thin flakes resulting in high aspect ratio platelet.

Thus, synthetic fluorine containing micas can be synthesized as, e.g., described in US 2014/0251184 A1 or using the Bridgman-Stockbarger method making use of platinum crucibles with seeds. Particularly fluorphlogopite is a widely used pigment, having the formula KMg₃AlSi₃O₁₀F₂. This fluorinated mica being the most important one in the present invention and being often used in cosmetic preparations.

In the present invention fluorinated mica, particularly preferred fluorphlogopite is used, which is covered or coated with titanium dioxide. How to coat synthetic micas with e.g., titanium dioxide is, e.g., disclosed in EP 3 719 081 A1, but also belongs to the state of the art since most mica products on the market are coated with metal oxides of different composition.

The herein used titanium dioxide coated fluorinated mica (P2) preferably contains only titanium dioxide as a coating. However, small amounts of other oxides in the coating, such as tin oxide and the like are acceptable. Furthermore, some grades may contain silanes as surface-modifiers in amounts of preferably 0 to 3 wt.-% based on the total weight of the pigment (P2).

The weight ratio of titanium dioxide to the fluorinated mica in the titanium dioxide coated fluorinated micas (P2) is preferably in the range from 3:7 to 7:3, more preferred from 3.5:6.5 to 6.5:3.5, or 4:6 to 6:4, based on the sum of the weights of the titanium dioxide coating of the fluorinated mica and fluorinated mica itself.

If present in the midcoat composition, the weight ratio of the platelet-shaped titanium dioxide coated fluorinated mica (P2) to the sum of film-forming polymers (A1) and crosslinkers (A2), i.e., (P2)/[(A1)+(A2)] is preferably in the range from 0.01 to 0.5, more preferred 0.05 to 0.3 and most preferred 0.1 to 0.28.

Such titanium dioxide coated fluorinated micas (P2), as employed in the manufacture of the midcoat compositions, preferably have a volume-based D₅₀ average particle size in the range from 2 to 40 μm, more preferred from 3 to 30 μm and most preferred in the range from 5 to 20 μm, such as 5 to 15 μm as determined by dynamic light scattering as described in the experimental section of the description and a platelet thickness from 50 nm to about 400 nm determined by electron microscopy as described in the experimental section of the description.

In the present invention it was found that these pigments are apt to reduce the graininess, while contributing to brightness and allowing a neutral or bluer hue. Particularly the smaller sized titanium dioxide coated fluorinated mica (P2) having D₅₀ values below 10 serve to provide lower graininess and a more straight-shade (i.e., non-metallic) look. Those having a D₅₀ value of 10 and larger, particularly give a brighter look (L* value) near specular reflection (+15°), but increases the graininess.

### Titanium Dioxide Coated Aluminum (P3)

The platelet-shaped titanium dioxide coated aluminum (P3) belongs to the group of “metal effect pigments”.

The term “metal effect pigment” is used in accordance with EN ISO 18451-1:2019 (Pigments, dyestuffs and extenders—Terminology—Part 1). Metal effect pigments are defined as platelet-shaped pigments consisting of metal. In the present invention the term “consisting of metal” includes a surface coating of the metal effect pigment, namely the presence of a titanium dioxide layer on the aluminum effect pigment. However, this does not exclude the presence of minor amounts, preferably less than 5 wt.-% based on the weight of the titanium dioxide coated aluminum (P3), of further metal oxides or semi-metal oxides in the coating applied to the aluminum. The aluminum effect pigments (P3) may also be treated with other agents such as functional silanes to stabilize the pigments against reaction and uptake of moisture, that may cause degradation of coating properties.

It was found by the inventors, that these titanium dioxide coated aluminum pigments (P3) serve to provide slight metallic look, and gives the multilayer coating a higher flop index, i.e., an enhanced metallic effect, and add to the blueness. Due to the preferably low amounts of these pigments (P3) they do not provide the typical overall metallic look of metallic coatings known in the art, but allow for a slight metallic impression of an otherwise straight-shade white look. Since the presence of these pigments leads to a darker flop at the viewing angle of +110°, it is to be used in low amounts only, to keep the L* values in the ranges given for the white color space.

Such titanium dioxide coated aluminum (P3), as employed in the manufacture of the midcoat compositions, preferably have a volume-based D₅₀ average particle size in the range from 5 to 20 μm, more preferred from 6 to 15 μm and most preferred in the range from 7 to 12 μm as determined by dynamic light scattering as described in the experimental section of the description and a platelet thickness of 50 to 200 nm determined by electron microscopy as described in the experimental section of the description.

Several (semi) metal oxide coated metallic pigments are known in the art. How to produce a titanium dioxide coated aluminum pigment is, e.g., disclosed in U.S. Pat. No. 5,026,429 already issued in the 1990's.

If present in the midcoat composition, the weight ratio of the titanium dioxide coated aluminum pigment (P3) to the sum of film-forming polymers (A1) and crosslinkers (A2), i.e., (P3)/[(A1)+(A2)] is preferably in the range from 0.001 to 0.2, more preferred 0.002 to 0.15 and most preferred 0.003 to 0.1.

Optional, but preferred non-platelet-shaped titanium dioxide Pigments (T*)

It is particularly preferred, that the midcoat compositions comprise, further to the platelet-shaped titanium oxide pigments (P), at least one non-platelet-shaped titanium dioxide pigment (T*). This non-platelet-shaped titanium dioxide pigment may further contain varying amounts of other metal oxides, such as zirconium dioxide or aluminum dioxide and/or metal hydroxides, such as zirconium hydroxide and aluminum hydroxide. Preferably a combination of zirconium dioxide and aluminum hydroxide. Typical amounts of the titanium dioxide in such non-platelet-shaped titanium dioxide pigments (T*) are from at least 80 wt.-% to 100 wt.-%, based on the total weight of non-platelet-shaped titanium dioxide pigments (T*). If other metal oxides and/or metal hydroxides are present, their combined amount maybe up to 20 wt.-%, but is preferably less than 15 wt.-% and more preferably less than 10 wt.-%, based on the weight of the non-platelet-shaped titanium dioxide pigments (T*). Most preferred are non-platelet-shaped titanium dioxide pigments (T*) containing titanium dioxide in an amount of at least 85 wt.-%, aluminum hydroxide in an amount of less than 10 wt.-%, more preferably less than 8 wt.-% and zirconium dioxide in an amount of less than 5 wt.-%, more preferably less than 3 wt.-%, all percentages being based on the total weight of the non-platelet-shaped titanium dioxide pigments (T*). Preferably, such pigments have a primary particle size in the range from 10 to 50 nm, more preferred 20 to 40 nm, such as 25 to 35 nm. Such pigments are, e.g., commercially available from Tayca Corporation or TTO-55A, TTO-55D, TTO-51A and TTO-51C from Ishihara.

While the above-mentioned non-platelet-shaped titanium dioxide pigments (T*) typically have low primary particle sizes, the commercial products contain aggregates and agglomerates of the primary particles leading to a heterogeneous mixture of these particles, thus having a large particle size distribution span [(D₉₀−D₁₀)/(D₅₀)] and high Z-average particle sizes, being much higher than the nominal primary particle size.

Therefore, the optional non-platelet-shaped, titanium dioxide pigments (T*) are preferably micromilled to possess even lower particle sizes than the commercial products.

Such titanium dioxide pigments (T*) can preferably be used as colloidal dispersion comprising these titanium dioxide particles (T*) having a Z-average particle size in the range from 30 nm to 220 nm as determined by dynamic light scattering; and having a particle size distribution span in the range from 0.7 to 1.5. Such dispersions further comprise one or more dispersing agents having groups which bind to the titanium dioxide particles. Such dispersions of micromilled titanium dioxide pigments (T*) can be obtained by first forming a pre-mix comprising one or more non-micromilled titanium dioxide pigments (T*) having a Z-average particle size >220 nm as determined by dynamic light scattering, and/or a particle size distribution span >1.5 and one or more dispersing agents comprising groups which bind to the one or more titanium dioxide pigments; and subsequently grinding the pre-mix obtained in the first step by use of a bead mill or shaker mill until titanium dioxide particles are obtained, which have a Z-average particle size in the range from 30 nm to 220 nm as determined by dynamic light scattering and have a particle size distribution span in the range from 0.7 to 1.5. The determination of the Z-average particle size as well as the D₁₀, D₅₀ and D₉₀ values used to calculate the particle size distribution span can be determined by dynamic light scattering using a Malvern Zetasizer (from Malvern, S90 unit, Nanoseries Model ZEN 1690 mfg May 2017) as described in the experimental section of the present invention.

The non-platelet-shaped, titanium dioxide pigments (T*) in general, but particularly those which were micromilled as describe above, can advantageously be used in this invention and can be utilized to reduce the graininess and contribute a bluish hue at the far off-specular viewing angle (+110°) and can provide optional whiter lighter L* at 110°, if desired to stay more toward a white straight shade than high metallic travel. However, if a large L* at an +15° angle is desired, non-platelet-shaped titanium dioxide pigments (T*) should not be used or only in low amounts.

The preferred dry-layer thickness of the midcoat layer or stack of midcoat layers ranges from 3 to 20 μm, more preferred from 4 to 15 μm, even more preferred from 5 to 10 μm, such as 6 to 8 μm.

The midcoat layer(s) are formed by application of midcoat compositions, which contain one or more of the above-mentioned platelet-shaped titanium oxide pigments (P).

The midcoat compositions are typically selected from one-pack compositions and two-pack compositions. They are preferably aqueous one-pack compositions.

If present in the midcoat composition, the non-platelet-shaped titanium dioxide pigment (T*) is present in an amount in the range from 0.01 to 2.0 wt.-%, more preferably in the range from 0.05 to 1.5 wt.-% and most preferred in the range from 0.1 to 1.0 wt.-%, based on the total weight of the midcoat composition.

If present in the midcoat composition, the weight ratio the non-platelet-shaped titanium dioxide pigment (T*) to the sum of film-forming polymers (A1) and crosslinkers (A2), i.e., (T*)/[(A1)+(A2)] is preferably in the range from 0.001 to 0.2, more preferred 0.003 to 0.1 and most preferred 0.004 to 0.08.

Preferably the midcoat layer(s) and midcoat composition(s) comprise at least two platelet-shaped titanium oxide pigments (P) selected from the group of hydrogen titanium oxide (P1), titanium dioxide coated fluorinated mica (P2) and titanium dioxide coated aluminum (P3).

More preferred, the midcoat layer(s) and midcoat composition(s) comprise at least one platelet-shaped hydrogen titanium oxide (P1) and at least one platelet-shaped titanium dioxide coated fluorinated mica (P2); or at least one non-platelet-shaped titanium dioxide pigment (T*) and at least one platelet-shaped titanium oxide (P) selected from the group consisting of hydrogen titanium oxide (P1) and titanium dioxide coated fluorinated mica (P2).

Even more preferred the midcoat layer(s) and midcoat composition(s) comprise at least one platelet-shaped titanium dioxide coated aluminum (P3), at least one non-platelet-shaped titanium dioxide pigment (T*) and additionally at least one platelet-shaped hydrogen titanium oxide (P1) and/or at least one platelet-shaped titanium dioxide coated fluorinated mica (P2).

The midcoat compositions are typically selected from one-pack compositions and two-pack compositions, which can be aqueous or solvent-based.

Herein preferred is the use of aqueous one-pack compositions as midcoat compositions.

Preferably, the solids content of the aqueous midcoat composition according to the invention is in a range from 15 to 30 wt.-%, more preferably from 16 to 27 wt.-%, most preferably from 17 to 25 wt.-%, in particular from 18 to 23 wt.-%.

Preferably, the solids content of the solventborne midcoat composition according to the invention is in a range from 30 to 70 wt.-%, more preferably from 40 to 60 wt.-%, most preferably from 45 to 58 wt.-%, in particular from 50 to 55 wt.-%.

Besides the afore-mentioned platelet-shaped titanium dioxide pigments (P) and non-platelet-shaped titanium dioxide pigments (T*) the midcoat compositions comprise at least one film-forming polymer (A1), if (A1) is externally crosslinkable, a crosslinking agent (A2), optionally one or more dyes (B1), pigments (B2) and/or fillers (B3), which differ from the platelet-shaped titanium oxide pigments (P1), (P2) and (P3), a solvent component(S) and further optional components (C) such as typical coatings additives, as rheology additives and the like. Since these afore-mentioned components of the midcoat composition might also be used in one or more of the other coating compositions (e.g., the ground coat compositions and clearcoat compositions), they are further described in a separate part of the description below.

### Clearcoat Layer and Clearcoat Composition

The clearcoat layer or clearcoat layers of the multilayer coating of the present invention are formed by applying one or more clearcoat compositions onto the only or last midcoat layer. The clearcoat composition applied can be a one-pack or a two-pack composition; and can be aqueous or solvent-based. Preferably, the clearcoat composition of the present invention is a solvent-based two-pack composition.

The clearcoat composition preferably comprises at least one binder, more preferably at least one polymer as binder.

Preferably, the clearcoat composition comprises at least one polymer having on average two or more OH-groups and/or amino groups and/or carbamate groups, more preferably OH-groups and/or carbamate groups, most preferred OH groups. Preferably, the at least one preferably at least OH— and/or carbamate functional polymer has a weight average molecular weight M_{w}, measured by means of gel permeation chromatography (GPC) against a polystyrene standard, preferably in the range from 800 and 100,000 g/mol, more preferred in the range from 1,000 and 75,000 g/mol.

If the clearcoat composition is formulated as a two-pack coating composition, it preferably contains at least one polyisocyanate having free NCO groups as crosslinker. If the clearcoat composition is formulated as a one-pack coating composition, it preferably contains at least one polyisocyanate having blocked NCO-groups and/or at least one melamine formaldehyde resin as crosslinker.

Suitable polyisocyanates for use as crosslinkers bear on average two or more NCO-groups.

Such crosslinker preferably has a cycloaliphatic structure and/or a parent structure that is derived from a cycloaliphatic polyisocyanate by trimerization, dimerization, urethane formation, biuret formation, uretdione formation and/or allophanate formation. Alternatively, or additionally, the at least one crosslinker preferably has an acyclic aliphatic structure and/or a parent structure that is derived from an acyclic aliphatic polyisocyanate by trimerization, dimerization, urethane formation, biuret formation, uretdione formation and/or allophanate formation. The acyclic aliphatic polyisocyanates-optionally serving as parent structures—are preferably substituted or unsubstituted aliphatic polyisocyanates that are known per se. Examples are tetramethylene 1,4-diisocyanate, hexamethylene 1,6-diisocyanate, 2,2,4-trimethylhexane 1,6-diisocyanate, ethylene diisocyanate, dodecane 1,12-diisocyanate, and mixtures of the aforementioned polyisocyanates. The cycloaliphatic polyisocyanates-optionally serving as parent structures—are preferably substituted or unsubstituted cycloaliphatic polyisocyanates which are known per se. Examples of preferred polyisocyanates are isophorone diisocyanate, cyclobutane 1,3-diisocyanate, cyclohexane 1,3-diisocyanate, cyclohexane 1,4-diisocyanate, methylcyclohexyl diisocyanates, hexahydrotoluene 2,4-diisocyanate, hexahydrotoluene 2,6-diisocyanate, hexahydrophenylene 1,3-diisocyanate, hexahydrophenylene 1,4-diisocyanate, perhydrodiphenylmethane 2,4′-diisocyanate, 4,4′-methylendicyclohexyl diisocyanate (e.g. Desmodur® W from Bayer AG) and mixtures of the aforementioned polyisocyanates. The crosslinkers bearing on average two or more NCO-groups can also be partially be silanized by hydrolysable silanes. Such silanized crosslinking agents are, e.g., disclosed in WO 2010/063332 A1, WO 2010/139375 A1 and WO 2009/077181 A1.

Particularly in case the clearcoat composition is a two-pack coating composition, it is most preferably a solvent-based clearcoat composition, since in aqueous compositions free NCO groups and the optionally contained hydrolysable silanes could give rise to an undesirable premature reaction with water.

Particularly suitable crosslinkers in particular in case the clearcoat compositions are formulated as one-pack coating compositions are melamine formaldehyde resins.

Although the above film-forming polymers and crosslinking agents can be used in the clearcoat composition, the clearcoat compositions are not limited to these. Thus, beside the above components, the clearcoat compositions can comprise one or more of the film-forming polymers (A1), if (A1) is externally crosslinkable, crosslinking agents (A2), solvents(S) and further optional components (C) such as typical coatings additives, as rheology additives and the like, as described below. Typically, clearcoat compositions do not contain hiding pigments and/or fillers, or even more preferred, they do not contain any pigments and/or fillers. However, in some cases the clearcoat composition may contain pigments, if such pigments provide only a very low haze or are transparent. Such pigments can, e.g., be micromilled titanium dioxide pigments T* as described above.

Preferably, the total solid content of the clearcoat composition is in the range of from 10 to 65 wt.-%, more preferably of from 15 to 60 wt.-%, even more preferably of from 20 to 50 wt.-%, in particular of from 25 to 45 wt.-%, in each case based on the total weight of the clearcoat composition.

The clearcoat layer(s) formed from the clearcoat composition(s) preferably have a dry-film thickness in the range from 20 to 60 μm, more preferred from 30 to 50 μm and even more preferred from 35 to 45 μm.

### Film-Forming Polymer (A1) for Use in the Ground Coat, Midcoat and Clearcoat Compositions

The inventive ground coat and midcoat compositions comprises at least one film-forming polymer as film-forming binder (A1) of the respective composition.

For the purposes of the present invention, the term (A1) is understood to be the non-volatile constituent of a coating composition, which is responsible for the film formation, excluding additives, particularly excluding the further additives (C). Preferably, at least one polymer of the at least one polymer (A1) is the main binder of the coating composition. As the main binder in the present invention, a binder component is preferably referred to, when there is no other binder component in the coating composition, which is present in a higher proportion based on the total weight of the coating composition.

The term “polymer” is known to the person skilled in the art and, for the purposes of the present invention, encompasses polyadducts and polymerizates as well as polycondensates. The term “polymer” includes both homopolymers and copolymers.

The at least one polymer used as component (A1) may be physically drying, self-crosslinkable or externally crosslinkable. Suitable polymers which can be used as component (A1) are, for example, described in EP 0 228 003 A1, DE 44 38 504 A1, EP 0 593 454 B1, DE 199 48 004 A1, EP 0 787 159 B1, DE 40 09 858 A1, DE 44 37 535 A1, WO 92/15405 A1 and WO 2005/021168 A1.

The at least one polymer used as component (A1) is preferably selected from the group consisting of polyurethanes, polyureas, polyesters, polyamides, poly(meth)acrylates and/or copolymers of the structural units of said polymers, in particular polyurethane-poly(meth)acrylates and/or polyurethane polyureas. The at least one polymer used as component (A1) is particularly preferably selected from the group consisting of polyurethanes, polyesters, poly(meth)acrylates and/or copolymers of the structural units of said polymers. The term “(meth)acryl” or “(meth)acrylate” in the context of the present invention in each case comprises the meanings “methacrylic” and/or “acrylic” or “methacrylate” and/or “acrylate”.

Preferred polyurethanes are described, for example, in German patent application DE 199 48 004 A1, page 4, line 19 to page 11, line 29 (polyurethane prepolymer B1), in European patent application EP 0 228 003 A1, page 3, line 24 to page 5, Line 40, European Patent Application EP 0 634 431 A1, page 3, line 38 to page 8, line 9, and international patent application WO 92/15405, page 2, line 35 to page 10, line 32.

Preferred polyesters are described, for example, in DE 4009858 A1 in column 6, line 53 to column 7, line 61 and column 10, line 24 to column 13, line 3 and Example D; or in WO 2014/033135 A2, page 2, line 24 to page 7, line 10 and page 28, line 13 to page 29, line 13. Likewise, polyesters may have a dendritic structure, as described, for example, in WO 2008/148555 A1.

Preferred polyurethane-poly(meth)acrylate copolymers (e.g., (meth)acrylated polyurethanes)) and their preparation are described, for example, in WO 91/15528 A1, page 3, line 21 to page 20, line 33 and in DE 4437535 A1, page 2, line 27 to page 6, line 22 described.

Preferred poly(meth)acrylates are those which can be prepared by multistage free-radical emulsion polymerization of olefinically unsaturated monomers in water and/or organic solvents. For example, seed-core-shell polymers (SCS polymers) are particularly preferred. Such polymers or aqueous dispersions containing such polymers are known, for example, from WO 2016/116299 A1.

Preferred polyurethane-polyurea copolymers are polyurethane-polyurea particles, preferably those having an average particle size of 40 to 2000 nm, the polyurethane-polyurea particles, each in reacted form, containing at least one isocyanate group-containing polyurethane prepolymer containing anionic and/or groups which can be converted into anionic groups and at least one polyamine containing two primary amino groups and one or two secondary amino groups. Preferably, such copolymers are used in the form of an aqueous dispersion. Such polymers can in principle be prepared by conventional polyaddition of, for example, polyisocyanates with polyols and polyamines.

The polymer used as component (A1) preferably has reactive functional groups which enable a crosslinking reaction. Any common crosslinkable reactive functional group known to those skilled in the art can be present. Preferably, the polymer used as component (A1) has at least one kind of functional reactive groups selected from the group consisting of primary amino groups, secondary amino groups, hydroxyl groups, thiol groups, carboxyl groups and carbamate groups. Preferably, the polymer used as component (A1) has functional hydroxyl groups.

Preferably, the polymer used as component (A1) is hydroxy-functional and more preferably has an OH number in the range of 10 to 500 mg KOH/g, more preferably from 40 to 200 mg KOH/g.

The polymer used as component (A1) is particularly preferably a hydroxy-functional polyurethane-poly(meth)acrylate copolymer, a hydroxy-functional polyester and/or a hydroxy-functional polyurethane-polyurea copolymer.

In addition, the coating composition of the present invention may contain at least one typical crosslinking agent known per se. Crosslinking agents (A2) are to be included among the film-forming non-volatile components of a coating composition, and therefore fall within the general definition of the “binder”.

The amounts of the film-forming polymer (A1) in the ground coat or midcoat composition is preferably in the range from 20 to 45 wt.-%, more preferred 25 to 35 wt.-% based on the total weight of the coating composition.

### Crosslinking Agent (A2) for Use in the Ground Coat, Midcoat and Clearcoat Compositions

If (A1) is externally crosslinkable, a crosslinking agent (A2) is needed for crosslinking, which preferably is at least one aminoplast resin and/or at least one blocked or free, preferably blocked polyisocyanate, and most preferably an aminoplast resin. Among the aminoplast resins, melamine resins such as melamine-formaldehyde resins are particularly preferred.

The amounts of the crosslinking agents (A2) in the ground coat or midcoat composition is preferably in the range from 3 to 20 wt.-%, more preferred 4 to 10 wt.-% based on the total weight of the coating composition.

### Further Dyes (B1), Pigments (B2) and Fillers (B3) for Use in the Ground Coat and Midcoat Composition and Clearcoat Composition

The ground coat, midcoat and clearcoat compositions of the invention, preferably only the ground coat compositions of the present invention may further contain a colorant and/or a filler, the colorant being selected from the group consisting of dyes (B1) and color and/or effect pigments (B2), excluding pigments (P), (T) and (T*) as described above. “Excluding” in this context means, that pigments (P), (T) and (T*) might of course be present, but are excluded from the definition of pigments (B), only. Thus, regarding e.g., the calculation of amounts, pigments (P), (T) and (T*) are not subsumed under pigments (B).

The term “dyes” (B1) (also called dyestuffs) denotes, contrary to pigments, colorants which are soluble in the surrounding medium. Suitable dyes can be organic or inorganic. It is not encouraged to use any soluble dye in any of the coating layers of the present invention, since they may change the color to depart from the white color space, as defined above. Therefore, the coating layers of the present invention are preferably free from dyes (B1). If dyes (B1) are used, they are preferably blue dyes in small amounts.

The term “pigments” as used for the color pigments (B2), but likewise for pigments (P) denotes colorants, which contrary to dyes, are essentially insoluble in the surrounding medium. The term includes color pigments and effect pigments. A person skilled in the art is familiar with the term effect pigments. A corresponding definition can be found, for example, in Römpp Lexikon, Lacke und Druckfarben, Georg Thieme Verlag, 1998, 10th Edition, pages 176 and 471.

A person skilled in the art is familiar with the concept of color pigments. The terms “coloring pigment” and “color pigment” are interchangeable. As a color pigment inorganic and/or organic pigments can be used. Preferably, the color pigment is an inorganic color pigment. Particularly preferred color pigments used are white pigments, colored pigments and/or black pigments. Examples of white pigments are titanium dioxide pigments, zinc white, zinc sulfide and lithopone. Examples of black pigments are carbon black, iron manganese black and spinel black. Examples of colored pigments are chromium oxide, chromium oxide hydrate green, cobalt green, ultramarine green, cobalt blue, ultramarine blue, manganese blue, ultramarine violet, cobalt and manganese violet, iron oxide red, molybdate red and ultramarine red, iron oxide brown, mixed brown, spinel and corundum phases and chromium orange, iron oxide yellow, nickel titanium yellow, chrome titanium yellow, cadmium sulfide, cadmium zinc sulfide, chrome yellow and bismuth vanadate.

It is not encouraged to use any color pigments (B2) in any of the coating layers of the present invention, particularly if they are not white or blue, since they may change the color to depart from the white color space, as defined above. Therefore, the coating layers of the present invention are preferably free from pigments (B2). If pigments (B2) are used, they are preferably blue dyes in small amounts. Blue pigments (B2) may add to a purer white look if used in small amount, particularly in the ground coat layer and less preferred in the midcoat layer. Particularly suitable are inorganic blue pigments, such as spinel type pigments, as, e.g., blue pigments of the cobalt aluminate spinel type.

Examples of further effect pigments-beside mandatory pigments (P1), (P2) and/or (P3)—are platelet-shaped metallic effect pigments, which differ from the aforementioned pigments (P), such as gold bronzes, fire-colored bronzes and/or iron oxide-aluminum pigments, pearlescent pigments, glass pigments and silica pigments, and/or natural mica pigments. Any of these platelet shaped effect pigment flakes may be coated with an additional compound to provide an absorption or interference-type color behavior. Coatings for the platelets may be metal oxides or organic colorants.

The term “filler” (C3) is known to the person skilled in the art, for example from DIN 55943 (date: October 2001). For the purposes of the present invention, a “filler” is understood to mean a substance which is essentially insoluble in the application medium, for example the coating composition according to the invention and which is used in particular for increasing the volume. In the context of the present invention, “fillers” preferably differ from “pigments” by their refractive index, which for fillers is <1.7, but for pigments is ≥1.7. Examples of suitable fillers are kaolin, dolomite, calcite, chalk, calcium sulfate, barium sulfate, talc, silicic acids, in particular pyrogenic silicic acids, hydroxides such as aluminum hydroxide or magnesium hydroxide, glass flakes and the like or organic fillers such as textile fibers, cellulose fibers and/or polyethylene fibers; in addition, reference is made to Rompp Lexikon Lacke und Druckfarben, Georg Thieme Verlag, 1998, pages 250 ff., “Fillers”.

As mentioned above, any of the afore-mentioned colorants (B1) and (B2) and fillers (B3) differs from pigments (P), (T) and (T*). If contained, (B1), (B2) and (B3) may be contained in the ground coat compositions and/or midcoat compositions, however, if contained, they are preferably only contained in the ground coat compositions,

Particularly, the total amount and kind of coloring dyes (B1) and/or coloring or coloring and effect-providing pigments (B2) and/or coloring fillers (B3) is chosen to give just a light tint to the overall white color impression of the multilayer coating, maintaining the white color impression within the above defined ranges of L* values as set forth for the multilayer coating of the present invention.

### Solvents(S) for Use in the Ground Coat, Midcoat and Clearcoat Compositions

The ground coat and midcoat composition comprise water and/or one or more organic solvents as component(S).

The total amount of water and organic solvent being present in the coating composition is the difference between the total weight of the composition and its solids content, it is also called “volatile content”.

If, the ground coat and midcoat compositions mainly comprise water as part of the volatile content, they are named aqueous or waterborne ground coat or midcoat compositions. This is preferred for the ground coat composition and midcoat composition.

All conventional organic solvents known to those skilled in the art can be used as organic solvents for the preparation of the coating composition of the invention. The term “organic solvent” is known to those skilled in the art, in particular from Council Directive 1999/13/EC of 11 Mar. 1999. Preferably, the one or more organic solvents are selected from the group consisting of monohydric or polyhydric alcohols, for example, methanol, ethanol, 1-propanol, 2-propanol, 1-butanol, 2-ethylhexanol, ethylene glycol, ethyl glycol, propyl glycol, butyl glycol, butyl diglycol, 1,2-propanediol and/or 1,3-propanediol; ethers, for example diethylene glycol dimethyl ether; aliphatic hydrocarbons, aromatic hydrocarbons, for example toluene and/or xylenes; ketones, for example acetone, N-methylpyrrolidone, N-ethylpyrrolidone, methyl isobutyl ketone, isophorone, cyclohexanone, methyl ethyl ketone; esters, for example methoxypropyl acetate, ethyl acetate and/or butyl acetate; amides, for example dimethylformamide and mixtures thereof.

### Further Optional Components of the Coating Composition (C) for Use in the Ground Coat Composition, Midcoat Composition and Clearcoat Compositions

The ground coat, midcoat and clearcoat compositions may optionally comprise one or more components, which are different from each of components (A1), (A2), (T), (T*), (P), (B1), (B2), (B3) and (S).

The ground coat, midcoat and clearcoat compositions as used to form the multilayer coating of the present invention may contain one or more commonly used additives (C) depending on the desired application. For example, the coating composition may comprise at least one additive selected from the group consisting of reactive diluents, such as polypropylene diols, light stabilizers, antioxidants, deaerators, emulsifiers, slip additives, polymerization inhibitors, plasticizers, initiators for free-radical polymerizations, adhesion promoters, flow control agents, film-forming auxiliaries, sag control agents (SCAs), flame retardants, corrosion inhibitors, biocides and/or matting agents. They can be used in the known and customary proportions. Preferably, their content, based on the total weight of the coating composition according to the invention is 0.01 to 25 wt.-%, more preferably 0.05 to 20 wt.-%, particularly preferably 0.1 to 15% by weight, most preferably from 0.1 to 10% by weight, especially from 0.1 to 7% by weight and most preferably from 0.1 to 5% by weight.

Amongst the additives, the coating composition according to the invention may optionally contain at least one thickener or rheology agent. Examples of such thickeners are inorganic thickeners, for example metal silicates such as sheet silicates, and organic thickeners, for example poly(meth)acrylic acid thickeners and/or (meth)acrylic acid (meth)acrylate copolymer thickeners, polyurethane thickeners and polymeric waxes. The metal silicate is preferably selected from the group of smectites. The smectites are particularly preferably selected from the group of montmorillonites and hectorites. In particular, the montmorillonites and hectorites are selected from the group consisting of aluminum-magnesium silicates and sodium-magnesium and sodium-magnesium fluorine-lithium phyllosilicates. These inorganic phyllosilicates are marketed, for example, under the trademark Laponite®. Thickeners based on poly(meth)acrylic acid and (meth)acrylic acid (meth)acrylate copolymer thickeners are optionally crosslinked and or neutralized with a suitable base. Examples of such thickening agents are “Alkali Swellable Emulsions” (ASE), and hydrophobically modified variants thereof, the “Hydrophically Modified Alkali Swellable Emulsions” (HASE). Preferably, these thickeners are anionic. Corresponding products such as Rheovis® AS 1130 are commercially available. Polyurethane based thickeners (e.g., polyurethane associative thickeners) are optionally crosslinked and/or neutralized with a suitable base. Corresponding products such as Rheovis® PU 1250 are commercially available. Examples of suitable polymeric waxes are optionally modified polymeric waxes based on ethylene-vinyl acetate copolymers. A corresponding product is commercially available, for example, under the name Aquatix® 8421.

It at least one thickener is present in the coating composition according to the invention, it is preferably present in an amount of at most 7% by weight, more preferably at most 5% by weight, most preferably at most 3% by weight, especially at most 2% by weight. %, most preferably not more than 1.5% by weight, based in each case on the total weight of the coating composition. The minimum amount of thickener is preferably in each case 0.1% by weight, based on the total weight of the coating composition.

The multilayer coatings provided in the present invention can also be described in terms of their coloristic properties. Thus, the multilayer coatings of the present invention comprise at least one ground coat layer, at least one midcoat layer and at least one clearcoat layer and typically possess
a lightness L* according to CIELab
   (i) in the viewing angle range from −15° to +45° of at least 80;
   (ii) at the viewing angle from +75° to +110° of at least 70, if a metal effect pigment is contained in the midcoat layer;
   (iii) at the viewing angle from +75° to +110° of at least 75, if no metal effect pigment is contained in the midcoat layer; and
   (iv) at the viewing angle of +15° of at least 105;
a graininess G_{diff} of ≤2.5; and
a liquid metal index LMI of ≥0.9.

Preferably, the lightness (L*) value is ≥108 and most preferred ≥110 or even ≥115 at a +15° viewing angle; preferably the lightness (L*) value ≥78, most preferred ≥80 or even ≥85 at a +110° viewing angle; preferably the graininess (G_{diff}) value being ≤2.2, most preferred ≤2.0 or even ≤1.8; and preferably the liquid metal index (LMI) value being ≥0.95, more preferred ≥1.0, most preferred ≥1.20 and preferably not higher than 5.

Furthermore, it is preferred that the white multilayer coatings possess a slight bluish tint, i.e., it is preferred that the b* value of the inventive multilayer coating is preferably ≤3, more preferred ≤1, most preferred ≤0 and even ≤−0.5 across the viewing angle range from −15° to 110°. In all cases the lower limit of b* preferably being-5 across viewing angles from −15° to 110°.

The description of the multilayer coatings by their coloristic properties, stands for itself, but any of the afore-mentioned coloristic values or value ranges may be combined with the description of the multilayer coatings of the present invention by the concrete ingredients and their typical amounts, such as the platelet-shaped titanium oxide pigments (P), the non-platelet-shaped pigments (T) and (T*), film-forming polymers (A1) and crosslinkers (A2), dyes (B1), pigments (B2), and fillers (B3) as well as solvents(S) and further components (C). The above description of these ingredients and their amounts allow to obtain the multilayer coatings with the respective coloristic properties. For each of the color relevant ingredients the influence on the above parameters is explained, allowing one of skill in the art to obtain multilayer coating as defined by their coloristic properties.

### Method of Preparing a Multilayer Coating and a Multilayer Coated Substrate

A further object of the present invention is a method for producing the multilayer coating, the method comprising
a. applying at least one ground coat composition on a coated or uncoated substrate to form one or more ground coat layer(s), the ground coat composition(s) comprising at least one non-platelet-shaped titanium dioxide pigment (T);
b. applying on the thus formed only or last ground coat layer(s) at least one midcoat composition to form one or more midcoat layer(s), the midcoat composition(s) comprising at least one platelet-shaped titanium oxide pigment (P) selected from the group consisting of hydrogen titanium oxide (P1), titanium dioxide coated fluorinated mica (P2) and titanium dioxide coated aluminum (P3); and
c. applying on the thus formed only or last midcoat layer(s) at least one clearcoat composition to form one or more clearcoat layer(s); and
d. curing the not yet cured or not yet fully cured ground coat layers, midcoat layers and/or clearcoat layers.

All preferred embodiments described hereinabove in connection with the inventive multilayer coating composition, and the preferred embodiments thereof, are also preferred embodiments of the inventive methods of preparing a coated or multilayer-coated substrate.

The substrate is preferably a pre-coated substrate, particularly if the substrate is a metal substrate. Said metal substrate then preferably bears a primer and/(or) an electrodeposition coating as pre-coating layers and/(or) a conversion coating layer as pre-treatment. If the substrate is a precoated or uncoated metal substrate, the metal is preferably steel or galvanized steel or aluminum or alloys of these.

The ground coat, midcoat and clearcoat coating compositions can be applied by numerous techniques well-known in the art, including spray coating, drop coating, dip coating, roll coating, curtain coating, and other techniques. Preferably, the inventive coating compositions are applied by spray coating, more preferred by pneumatic or electrostatic spray coating. It can be applied wet-on-wet, but does not have to.

The substrate used can be a plastic substrate, i.e., a polymeric substrate. Preferably, thermoplastic polymers are used as such substrates. Suitable polymers are poly(meth)acrylates including polymethyl(meth)acrylates, polybutyl(meth)acrylates, polyethylene terephthalates, polybutylene terephthalates, polyvinylidene fluorides, polyvinyl chlorides, polyesters, including polycarbonates and polyvinyl acetate, polyamides, polyolefins such as polyethylene, polypropylene, polystyrene, and also polybutadiene, polyacrylonitrile, polyacetal, polyacrylonitrile-ethylene-propylene-diene-styrene copolymers (A-EPDM), ASA (acrylonitrile-styrene-acrylic ester copolymers) and ABS (acrylonitrile-butadiene-styrene copolymers), polyetherimides, phenolic resins, urea resins, melamine resins, alkyd resins, epoxy resins, polyurethanes, including TPU, polyetherketones, polyphenylene sulfides, polyethers, polyvinyl alcohols, and mixtures thereof. Polycarbonates and poly(meth)acrylates are especially preferred. The substrate can also be a composite substrate such as a fiber reinforced substrate containing e.g., glass fibers, carbon fibers or polymeric fibers such as polyamide fibers. The substrate can also consist of multiple polymeric layers.

Further, the substrate used can be glass or textiles, in particular glass.

### Coated or Multilayer-Coated Substrates

A further subject-matter of the present invention is an at least partially multilayer coated substrate obtainable by one of the afore-mentioned methods for producing a multilayer coated substrate.

All preferred embodiments described hereinabove in connection with the inventive coating compositions, as well as the inventive methods and the preferred embodiments thereof, are also preferred embodiments of the inventive coated or multilayer-coated substrates.

The coated substrates are preferably automotive bodies and parts thereof.

### EXAMPLES

In the following all amounts are in parts by weight and all percentage values are in weight-%, if not indicated otherwise.

### Preparation of Coating Compositions

Preparation of Midcoat Compositions and Ground coat Composition

The ingredients of midcoat compositions A and B (i.e., basecoat compositions in a three-layer coating) are shown in Tables 3 and 4.

Midcoat compositions A and B as used in the present invention are aqueous one-pack midcoat compositions, each comprising one or a combination of the following platelet-shaped titanium oxide pigments:
a flake-shaped titanium dioxide coated fluorinated mica effect pigment (Automotive Rutile Micro White A-901-F OPB and/or Automotive Rutile Fine White A-901-D-OPB from CQV) (according to the invention),
a flake-shaped hydrogen titanium oxide (LPT-106 from Ishihara) (according to the invention), and
a flake-shaped titanium dioxide coated aluminum pigment (according to the invention); or
a flake-shaped titanium dioxide coated non-fluorinated mica effect pigment (Ext. Mearlin Micro White 139M) (not according to the invention)

Midcoat Compositions A further contain a non-platelet-shaped titanium dioxide pigment (Tacaya MT500 HD), employed in form of a pigment paste as described in Table 1.

The ingredients of the ground coat composition are shown in Table 2.

The ground coat compositions are aqueous one-pack compositions, each comprising a non-platelet-shaped titanium dioxide pigment and additionally another non-platelet-shaped colorant as shown in Table 2, both being incorporated into the ground coat composition in form of pigment pastes as described in Table 1.

The clearcoat composition was a commercial conventional solvent-borne two-component coating compositions based on the crosslinking hydroxyl group containing polymers with polyisocyanate.

### Preparation of Multilayer Coatings (Three-Layer Coatings)

The ground coat composition A and B were applied onto a baked primer layer by pneumatic application to form a ground coat layer having a dry-layer thickness of approx. 33 μm (ground coat layer A from ground coat composition A) and approx. 17 μm (ground coat layer B from ground coat composition B).

On top of the ground coat layer A, midcoat composition A was applied, after a 1- to 3-minute flash, wet on wet with ESTA bell and on top of the ground coat layer B, midcoat composition B was applied, after a 1- to 3-minute flash, by pneumatic application to form a midcoat layers A and B, respectively, having a dry-layer thickness of approx. 7 μm (midcoat layer A from midcoat composition A) and 10 μm (midcoat layer B from midcoat composition B).

Subsequently the two-component clearcoat composition was pneumatically applied, after a 3- to 5-minute heated (63° C.). The clearcoat was a two-component polyurethane paint applied to a dry-layer thickness of approx. 40-50 μm.

The thus coated panel was flashed for 5 to 10 minutes and then cured at 130° C. for 25 minutes.

TABLE 1
Pigment Pastes PP1 and PP2 (for Ground coat Composition) and Pigment Paste PP3 (for Midcoat Compositions A)

| | Amount by weight | | |
|---|---|---|---|
| Pigment Paste Ingredients | PP1 | PP2 | PP3 |
| TiPure R706 (titanium dioxide) (non-platelet-shaped titanium dioxide pigment T) | 69.0 | — | — |
| Tayca MT500 HD (non-platelet-shaped titanium dioxide pigment T*) | — | — | 20.0 |
| Heucodur 500 (inorganic blue) (blue pigment (B2) | — | 33.0 | — |
| Acrylic Resin A (35.5 wt % solids, 29 wt. % propylene glycol propyl ether, 29 wt. % H₂O, 6.5 wt. % ketone) | 6.2 | — | — |
| Acrylic Resin B (35.5 wt % solids, 29 wt. % propylene glycol propyl ether, 29 wt. % H₂O, 6.5 wt. % ketone) | — | — | — |
| PU dispersion E (44 wt. % PU solids, 56 wt. % H₂O) | — | 47.0 | — |
| Tego Dispers 752W | — | — | 20.0 |
| Water | 23.6 | 12.7 | 57.5 |
| Propylene glycol ether | 1.2 | — | 2.5 |
| Agitan 281 | — | 0.3 | — |
| Disperbyk 184 | — | 4.0 | — |
| Pluricol ® P-1010 (BASF SE) (colloidal agent) | — | 3.0 | — |
| Sum | 100.0 | 100.0 | 100.0 |

TABLE 2
Ground coat Composition (for use under Midcoat Compositions A and B)

| | | Amount by weight | |
|---|---|---|---|
| Ground coat | Ingredients | Ground Coat A | Ground Coat B |
| Aqueous | Titanium dioxide dispersion PP1 | 29.9 | 29.9 |
| Phase | Inorganic blue dispersion PP2 | 0.05 | 0.075 |
| | PU dispersion D (40.5 wt. % PU in 38 wt. % H₂O, | 14.7 | 14.7 |
| | 7 wt. % ketone, 3 wt. % propylene glycol ether, 11.5 wt. % dipropylene glocol ether) | | |
| | PU dispersion C (Daotan ® VTW 6462/36WA) | 2.4 | 2.4 |
| | PU dispersion B (35.5 wt. % PU solids, 8.5 wt. % butyl glycol, 56 wt. % H₂O) | 2.4 | 2.4 |
| | PU dispersion A (27 wt. % PU solids, 4 wt. % ketone, 4 wt. % Pluricol P1010, 65 wt. % H₂O) | 9.2 | 9.2 |
| | 2-Ethylhexanol | 1.8 | 1.8 |
| | BYK 345 | 0.3 | 0.3 |
| | Water | 7.7 | 7.7 |
| | 3.5 wt. % Laponite RD + 3.5 wt. % Pluricol P1010 in H₂O | 11.8 | 11.8 |
| | Tripropylene glycol monomethyl ether | 1.8 | 1.8 |
| | Dipropylene glycol propyl ether | 3.2 | 3.2 |
| | Butyl glycol | 2.6 | 2.6 |
| | Triisobutyl phosphate | 0.9 | 0.9 |
| | Shellsol ™ OMS | 0.9 | 0.9 |
| | Cymel ® 327 (melamine crosslinker) | 6.4 | 6.4 |
| Adjustment | N,N-dimethylethanolamine | 0.1 | 0.1 |
| | water | 3.85 | 3.825 |

| | | |
|---|---|---|
| Sum | 100.0 | 100.0 |

TABLE 3
Midcoat Compositions A (with different platelet-shaped titanium oxide coated pigments)

| | | Amount by weight | | |
|---|---|---|---|---|
| Midcoat Compositions A | Ingredients | C A1 | E A2 | E A3 |
| | PU dispersion C (Daotan ® VTW 6462/36WA) | 3.5 | 3.5 | 3.5 |
| | PU dispersion B (35.5 wt. % PU, 8.5 wt. % butyl glycol, 56 wt. % H₂O) | 3.6 | 3.6 | 3.6 |
| | PU dispersion A (27 wt. % PU solids, 4 wt. % ketone, 4 wt. % Pluricol P1010, 65 wt. % H₂O) | 18.6 | 18.6 | 18.6 |
| | Pluricol P1010 | 1.1 | 1.1 | 1.1 |
| | Viscalex HV30 blend in water | 4.2 | 4.2 | 4.2 |
| | Glycol ether TPM | 1.1 | 1.1 | 1.1 |
| | 2-Ethylhexanol | 1.8 | 1.8 | 1.8 |
| | TMDD BG 52 (52 wt.-% in butyl glycol) | 0.7 | 0.7 | 0.7 |
| | BYK 345 | 0.1 | 0.1 | 0.1 |
| | Titanium Dioxide Dispersion PP3 | 1.0 | 1.0 | 1.0 |
| | Water | 7.5 | 7.5 | 7.5 |
| | 3.5 wt. % Laponite RD + 3.5 wt. % Pluricol P1010 in H₂O (thickener) | 36.1 | 36.1 | 36.1 |
| | Shellsol ™ OMS | 0.8 | 0.8 | 0.8 |
| | DSX ® 1550 (20.5% in 19.5% water and 50% butyl cellosolve and 10% butyl carbitol) | 0.5 | 0.5 | 0.5 |
| | Resimene ® HM 2608 (melamine crosslinker) | 4.2 | 4.2 | 4.2 |
| | N,N-dimethylethanolamine | 0.1 | 0.1 | 0.1 |
| Organic Phase | Ext. Mearlin Micro White 139M (non-inventive natural mica pigment (coated with TiO₂ and Cr₂O₃)) | 1.9 | — | — |
| | LPT-106 from Ishihara (hydrogen titanium oxide (P1)) | — | 1.9 | — |
| | CQV Automotive Rutile Micro White A-901-F OPB (titanium dioxide coated fluorinated mica (P2)) | — | — | 1.9 |
| | Butyl glycol | 4.3 | 4.3 | 4.3 |
| | Polyester (Example D, DE 4009858 A1, col. 16, I. 37-59) | 1.6 | 1.6 | 1.6 |
| | N,N-dimethylethanolamine (20 wt.-% in water) | 0.2 | 0.2 | 0.2 |
| Adjustment | N,N-dimethylethanolamine | 0.1 | 0.1 | 0.1 |
| | water | 7.0 | 7.0 | 7.0 |

| | | | |
|---|---|---|---|
| Sum | 100.0 | 100.0 | 100.0 |

TABLE 4
Midcoat Compositions B (white colored without and with platelet-shaped titanium dioxide coated aluminum pigment)

| | | Amount by | |
|---|---|---|---|
| | | weight | |
| Midcoat Compositions B | Ingredients | E B1 | E B2 |
| | PU dispersion B⁴ | 4.8 | 4.8 |
| | PU dispersion A³ | 38.7 | 38.7 |
| | BYK ® 345 | 0.2 | 0.2 |
| | 3.5 wt. % Laponite RD + 3.5 wt. % Pluricol P1010 in H₂O | 25.2 | 25.2 |
| | Tinuvin 1130 | 0.3 | 0.3 |
| | Cymel ® 327 (melamine crosslinker) | 3.7 | 3.7 |
| | N,N-dimethylethanolamine | 0.1 | 0.1 |
| Organic Phase | Platelet-shaped titanium dioxide coated aluminum pigment P3 (55 wt.-% Al pigment in iso-propanol) | 0.0 | 0.1 |
| | LPT-106 from Ishihara (hydrogen titanium oxide (P1)) | 1.9 | 1.9 |
| | CQV Automotive A-901-F-OPB Micro White (titanium dioxide coated fluorinated mica (P2)) | 0.6 | 0.6 |
| | Passivator VP 75166 | 0.1 | 0.1 |
| | Butyl glycol | 7.2 | 7.2 |
| | Polyester (Example D, DE4009858A1, col. 16, I. 37-59) | 2.3 | 2.3 |
| | N,N-dimethylethanolamine (20 wt.-% in water) | 0.2 | 0.2 |
| Adjustment | N,N-dimethylethanolamine | 0.0 | 0.0 |
| | water | 14.7 | 14.6 |

| | | |
|---|---|---|
| Sum | 100.0 | 100.0 |

### Results

### Determination of L*, a*, b*, C* and h Values

The color data of the three-layer coatings were determined by use of a Byk Mac i instrument (from Byk Gardner GmbH, Germany). The illumination was a D65 illumination (observer angle) 10°. The multi-angle (viewing angles: −15°, +15°, +25°, +45°, +75°, +110°) measurement geometry is shown in FIG. 1. The angle of 110° is also denoted as “flop angle”.

By use of the afore-mentioned instrument the L*, a* and b* values of the two-layer coatings and the three-layer coatings were determined. C* is calculated by use of the following equation: C*=(a²+b²)^{0.5} and h=arctan(b/a).

The CIELAB formula defines a color space that is characterized by an a*-axis, that goes from green to red, and by a b*-axis, extending from blue to yellow, as well as a lightness axis L*, that is perpendicular to the other two. Negative values of b* mean that the color is bluish, while positive values of b* stand for a more yellowish color. High values for L* (i.e., lightness) stand for lighter colors, while low values of L* stand for darker colors.

In the following the respective color values as well as the difference of these values in the color space ΔL*, Δa+ and Δb+ are shown for the two-layer coatings containing Pastes A and B, respectively, in the basecoat layer; and for the three-layer coatings containing Pastes A and B, respectively, in the midcoat layer and in the latter case other coloring pigments in the ground coat layer.

### Calculation of the Flop Index Fᵢ

The flop index was calculated according the following equation:

$$Flop index = \frac{2.69 {( {L}_{15 °}^{*} - {L}_{110 °}^{*} )}^{1.11}}{{( {L}_{45 °}^{*} )}^{0.86}}$$

wherein L* was measured using the BYK Mac i instrument from Byk Gardner. The flop was determined on the multilayer system as described above.
Determination of the Sparkle Area Sₐ and Sparkle Intensity Sᵢ

The sparkle impressions change with the angle of illumination. Therefore, the sparkle of the three-layer coatings was measured with a BYK-mac i spectrophotometer illuminating the samples under three different angles 15°/45°/75° with very bright LEDs and taking pictures with the CCD camera located at the perpendicular (see FIG. 2).

The pictures were analyzed by image analyzing algorithms of the BYK mac i spectrophotometer using the histogram of lightness levels as the basis for calculating sparkle parameters. To allow better differentiation, the impression of sparkle was described by a two-dimensional system: sparkle area (Sₐ) and sparkle intensity (Sᵢ) for each angle.

For simplicity the sparkle area and intensity were summarized in one value, the sparkle grade (SG).

### Determination of the Graininess G_{diff}

The graininess (G_{diff}) of the three-layer coatings was evaluated by taking a picture with the CCD camera under diffused lighting conditions, created by a white coated hemisphere. The picture was analyzed using the histogram of lightness levels whereby the uniformity of light and dark areas was summarized in one graininess value, calculated by the BYK mac i spectrophotometer.

A graininess value of zero indicates a solid color, the higher the value the grainier or coarser the sample looks under diffused light.

### Calculation of the Liquid Metal Index LMI

The liquid metal index was calculated by the following equation:

$$LMI = {F}_{i} / {G}_{diff} ,$$

wherein the flop index Fᵢ and the graininess G_{diff} were calculated/determined as described above.

### Determination of the Particle Size Distribution and Z-Average Particle Size of Non-Platelet-Shaped Titanium Dioxide Pigments

The afore-mentioned parameters were determined by use of the above Malvern Zetasizer (from Malvern, S90 unit, Nanoseries Model ZEN 1690 mfg May 2017) using dynamic light scattering. To carry out the measurements, the pigment dispersions were diluted with appropriate solvent (deionized water for aqueous dispersion and organic solvent for solvent-based dispersion) not to exceed a photon count rate of approx. 300 to 500 counts when the unit is placed on an attenuator setting of 7. The operation temperature is held a 25±1° C. and the sample size is approx. 10 to 15 mL (square glass cuvette).

The procedure was as follows:

Typically, the photon count rate is in the above range, if 0.07 g of a paste containing 20 wt.-% of the pigment is first diluted into 15.0 g of deionized water and subsequently 5 drops of this solution are again diluted in to 15.0 g of deionized water. If the pigment paste contains more or less than 20 wt.-% of the pigment, the initial amount of 0.07 g should be decreased or increased accordingly.

With such twice-diluted paste the volume-based D₁₀, D₅₀ and D₉₀ values were determined. D₁₀ defines that the portion of particles with diameters smaller than this value is 10%. D₅₀ defines that the portions of particles with diameters smaller this value are 50% and is also known as the median diameter. D₉₀ defines that the portion of particles with diameters below this value is 90%.

### Determination of the Lateral Dimension and its Distribution of Platelet-Shaped Pigments

The lateral dimension of flake pigments (P1), (P2) and (P3) was measured by dynamic light scattering using a Mastersizer® 3000 Particle Size Analyzer (Malvern Instruments, Southborough, MA), after the samples were dispersed in deionized water containing 0.04% Igepal CA 630 surfactant. Results were reported in terms of a volume-weighted mean diameter D [4,3]. The diameter at which 10%, 50% and 90% of the population is smaller is given as D₁₀, D₅₀ and D₉₀.

### Determination of the Platelet-Thickness of Pigments

The platelet-thickness can be determined as follows: First the flake pigment is dispersed in appropriate solvent and incorporated in the midcoat composition. Then, the midcoat composition containing the platelet-shaped pigment is sprayed on a substrate and cured. The thus obtained film was peeled off from the edge of the sample and small pieces of films were cut by microtome using a diamond knife and thin sections were transferred onto TEM grids. Thin sections were examined on STEM or TEM to determine the thickness of the respective flake pigment.

### Determination of the Dry-Layer Thickness of the Coating Layers

The dry-layer thickness of the coating layer of the present invention was determined by use of an Elcometer such as a Fischer Dualscope FMP20C.

### Three-Layer Coatings (Ground Coat A—Midcoat A—Clearcoat)

In Tables 5-1, 5-2 and 5-3, three additional three-coat layer coatings are compared, the first one (C A1) making use of a midcoat layer containing a traditional microfine titanium dioxide and chromium (III) oxide coated natural mica, a second one, (E A2), wherein the titanium dioxide coated mica was substituted with a platelet comprising an oxide of titanium, and a third, (E A3), where the titanium dioxide coated natural mica in (C A1) was substituted with an ultrafine synthetic-based titanium dioxide-coated mica (fluorphlogopite) (see Table 3).

TABLE 5-1

| Midcoat A | Off-Specular (°) | L* | a* | b* | C* | h | Fᵢ |
|---|---|---|---|---|---|---|---|
| C A1 | −15 | 101.81 | −3.42 | 1.98 | 3.95 | 149.95 | 0.77 |
| | +15 | 101.42 | −2.81 | 2.58 | 3.82 | 137.37 | |
| | +25 | 98.78 | −2.42 | 2.78 | 3.69 | 131.01 | |
| | +45 | 94.75 | −1.96 | 3.22 | 3.77 | 121.33 | |
| | +75 | 93.04 | −1.60 | 2.89 | 3.31 | 119.01 | |
| | +110 | 90.42 | −1.67 | 2.99 | 3.43 | 119.20 | |
| E A2 | −15 | 116.09 | −2.20 | −4.15 | 4.70 | 242.11 | 1.95 |
| | +15 | 113.31 | −1.96 | −3.11 | 3.68 | 237.74 | |
| | +25 | 102.53 | −1.83 | −1.10 | 2.13 | 211.08 | |
| | +45 | 91.95 | −1.62 | 2.46 | 2.94 | 123.37 | |
| | +75 | 90.05 | −1.51 | 3.11 | 3.46 | 115.99 | |
| | +110 | 88.41 | −1.61 | 2.57 | 3.03 | 122.06 | |
| E A3 | −15 | 109.99 | −3.60 | 2.52 | 4.40 | 145.07 | 1.38 |
| | +15 | 108.12 | −2.72 | 3.05 | 4.09 | 131.77 | |
| | +25 | 102.57 | −2.13 | 2.98 | 3.66 | 125.52 | |
| | +45 | 94.36 | −1.44 | 2.90 | 3.24 | 116.45 | |
| | +75 | 91.21 | −1.00 | 2.46 | 2.66 | 112.15 | |
| | +110 | 89.56 | −1.11 | 2.75 | 2.96 | 111.98 | |

In the near off-specular range (−15° to +15° angle) there is a pronounced increase in brightness in E A2. Additionally, the difference between the −15° angle to +15° angle is greater with the titanium dioxide and chromium (III) oxide coated natural mica containing midcoat, indicating more of a metal-like behavior. In the far off-specular +110° angle the b* value is strongly reduced (more bluish) with the addition of the titanium dioxide coated synthetic mica and especially with the oxide of titanium, thus standing for a more bluish tint, and hence, a purer white look. The overall texture did not increase greatly versus the control material and still maintains a silky look with a Graininess (G_{diff}) value of <1.7 (see Tables 5-2 and 5-3).

TABLE 5-2

| Midcoat A | Off-Specular (°) | Sₐ | Sᵢ | SG | G_{diff} | LMI |
|---|---|---|---|---|---|---|
| C A1 | S15 | 1.82 | 1.41 | 0.00 | 1.09 | 0.71 |
| | S45 | 1.07 | 1.05 | 0.00 | | |
| | S75 | 0.00 | 0.00 | 0.00 | | |
| E A2 | S15 | 4.28 | 2.23 | 0.28 | 1.63 | 1.20 |
| | S45 | 0.55 | 0.55 | 0.00 | | |
| | S75 | 0.00 | 0.00 | 0.00 | | |
| E A3 | S15 | 6.28 | 2.92 | 0.70 | 1.43 | 0.97 |
| | S45 | 2.97 | 1.93 | 0.04 | | |
| | S75 | 0.43 | 1.03 | 0.00 | | |

TABLE 5-3

| Midcoat Variations A | Off-Specular (°) | ΔL* | Δa* | Δb* |
|---|---|---|---|---|
| Δ [E A2 − C A1] | −15 | 14.28 | 1.22 | −6.13 |
| | +15 | 11.89 | 0.84 | −5.69 |
| | +25 | 3.74 | 0.59 | −3.88 |
| | +45 | −2.80 | 0.34 | −0.76 |
| | +75 | −2.99 | 0.09 | 0.21 |
| | +110 | −2.01 | 0.06 | −0.42 |
| Δ [E A3 − C A1] | −15 | 8.18 | −0.18 | 0.54 |
| | +15 | 6.71 | 0.08 | 0.46 |
| | +25 | 3.79 | 0.29 | 0.20 |
| | +45 | −0.38 | 0.52 | −0.32 |
| | +75 | −1.83 | 0.60 | −0.43 |
| | +110 | −0.86 | 0.56 | −0.25 |

The differences (Δ) in the color values particularly in ΔL* and Δb* show a favorable color as a result of introduction of a titanium dioxide coated synthetic micas or oxide of titanium platelets to the midcoat.

### Three-Layer Coatings (Ground Coat B—Midcoat B—Clearcoat)

In Tables 6-1 and 6-2 two three-coat layer coatings are compared, the first one (C B1) making use of a midcoat layer containing no titanium dioxide coated aluminum, and a second one (E B2), wherein the titanium dioxide coated aluminum was added. Although C B1 is comparative to E B2, it still belongs to the invention and is just to show a further improvement of the coating composition by adding a small amount of the titanium dioxide coated aluminum flakes. Both midcoat compositions A further comprise an oxide of titanium (LPT-106 from Ishihara), and a titanium dioxide coated mica effect pigment (Automotive Rutile Micro White A-901-F OPB) (see Table 4).

TABLE 6-1

| Midcoat B | Off-Specular (°) | L* | a* | b* | C* | h | Fᵢ |
|---|---|---|---|---|---|---|---|
| C B1 | −15 | 121.91 | −2.22 | −0.58 | 2.3 | 194.57 | 2.78 |
| | +15 | 117.01 | −1.90 | −0.37 | 1.94 | 191.05 | |
| | +25 | 104.48 | −1.98 | −0.62 | 2.08 | 197.29 | |
| | +45 | 89.70 | −1.92 | 0.50 | 1.98 | 165.35 | |
| | +75 | 84.74 | −1.74 | 1.44 | 2.26 | 140.36 | |
| | +110 | 83.46 | −1.84 | 1.53 | 2.39 | 140.28 | |
| E B2 | −15 | 127.18 | −2.31 | −0.57 | 2.38 | 193.86 | 3.49 |
| | +15 | 119.85 | −1.94 | −0.46 | 1.99 | 193.46 | |
| | +25 | 104.17 | −1.97 | −0.94 | 2.19 | 205.55 | |
| | +45 | 86.24 | −1.85 | 0.03 | 1.85 | 179.20 | |
| | +75 | 80.81 | −1.69 | 0.96 | 1.94 | 150.44 | |
| | +110 | 79.94 | −1.84 | 1.04 | 2.11 | 150.46 | |

In the near off-specular range (−15° to +15°) there is a pronounced increase in brightness in E B2. Additionally, the difference between the −15° angle to the +15° angle is greater with the aluminum-containing midcoat, indicating more of a metal-like behavior. In the far off-specular range (+75° and +110° angles) the b* value is reduced (more bluish) with the addition of the titanium dioxide coated aluminum, thus standing for a more bluish tint, and hence, a purer white look.

TABLE 6-2

| Midcoat B | Off-Specular (°) | ΔL* | Δa* | Δb* |
|---|---|---|---|---|
| Δ [E B2 − C B1] | −15 | 5.26 | −0.08 | 0.01 |
| | +15 | 2.84 | −0.04 | −0.09 |
| | +25 | −0.30 | 0.01 | −0.33 |
| | +45 | −3.46 | 0.07 | −0.48 |
| | +75 | −3.93 | 0.05 | −0.48 |
| | +110 | −3.52 | 0.00 | −0.49 |

The differences (Δ) in the color values particularly in ΔL* and Δb* show a favorable color as a result of introduction of a titanium dioxide coated aluminum to the midcoat.

TABLE 6-3

| Midcoat A | Off-Specular (°) | Sₐ | Sᵢ | SG | G_{diff} | LMI |
|---|---|---|---|---|---|---|
| E B1 | S15 | 5.19 | 2.55 | 0.47 | 1.63 | 1.71 |
| | S45 | 3.37 | 1.91 | 0.09 | | |
| | S75 | 0.81 | 1.61 | 0.00 | | |
| E B2 | S15 | 4.51 | 2.52 | 0.38 | 1.70 | 2.05 |
| | S45 | 3.70 | 1.96 | 0.14 | | |
| | S75 | 0.81 | 1.53 | 0.00 | | |

1. A multilayer coating comprising
a) at least one ground coat layer, the at least one ground coat layer comprising at least one non-platelet-shaped titanium dioxide pigment (T);
b) at least one midcoat layer on top of the at least one ground coat layer, the midcoat layer comprising
i. at least one platelet-shaped titanium oxide pigment (P) selected from the group consisting of hydrogen titanium oxide (P1), titanium dioxide coated fluorinated mica (P2) and titanium dioxide coated aluminum (P3); and
c) at least one clearcoat layer on top of the at least one midcoat layer;
having a lightness L* according to CIELab
(i) in the viewing angle range from −15° to +45° of at least 80;
(ii) in the viewing angle range from +75° to +110° of at least 70, if a metal effect pigment is contained in the midcoat layer; and
(iii) in the viewing angle range from +75° to +110° of at least 75, if no metal effect pigment is contained in the midcoat layer; and
possessing a graininess (G_{diff}) of ≤2.5.

2. The multilayer coating according to claim 1, wherein the b) at least one midcoat layer further comprises
ii. at least one non-platelet-shaped titanium dioxide pigment (T).

3. The multilayer coating according to claim 1, wherein the b) at least one midcoat layer comprises
i. at least two platelet-shaped titanium oxide pigments (P) selected from the group of hydrogen titanium oxide (P1), titanium dioxide coated fluorinated mica (P2) and titanium dioxide coated aluminum (P3).

4. The multilayer coating according to claim 1, wherein the b) at least one midcoat layer comprises
a. at least one platelet-shaped hydrogen titanium oxide and at least one platelet-shaped titanium dioxide coated fluorinated mica; or
b. at least one non-platelet-shaped titanium dioxide pigment (T*) and at least one platelet-shaped titanium oxide (P) selected from the group consisting of hydrogen titanium oxide and titanium dioxide coated fluorinated mica.

5. The multilayer coating according to claim 1, wherein the b) at least one midcoat layer comprises at least one platelet-shaped titanium dioxide coated aluminum.

6. The multilayer coating according to claim 1, wherein the hydrogen titanium oxide is represented by one of the following formulae H₂Ti₃O₇ and H_{4x/3} Ti_{2-x/3}O₄·nH₂O, wherein x is 0.50 to 1.0, and n is 0 to 2; and/or the fluorinated mica is a fluorphlogopite.

7. The multilayer coating to claim 1, with a* being from −3.8 to +3.8 and b* being from −5 to +4, according to CIELab system at viewing angles of −15°, +15°, +25°, +45°, +75°, and +110°.

8. A multilayer coating comprising at least one ground coat layer, at least one midcoat layer and at least one clearcoat layer and possessing
a lightness L* according to CIELab
(i) in the viewing angle range from −15° to +45° of at least 80;
(ii) in the viewing angle range from +75° to +110° of at least 70, if a metal effect pigment is contained in the midcoat layer;
(iii) in the viewing angle range from +75° to +110° of at least 75, if no metal effect pigment is contained in the midcoat layer; and
(iv) at the viewing angle of +15° of at least 105;
a graininess G_{diff} of ≤2.5; and
a liquid metal index LMI of ≥0.9.

9. A multilayer coating according to claim 8,
wherein:
the at least one ground coat layer comprises at least one non-platelet-shaped titanium dioxide pigment (T); and
the midcoat layer comprises at least one platelet-shaped titanium oxide pigment (P) selected from the group consisting of hydrogen titanium oxide (P1), titanium dioxide coated fluorinated mica (P2) and titanium dioxide coated aluminum (P3).

10. A method for producing the multilayer coating according to claim 1, the method comprising
a. applying at least one ground coat composition on a coated or uncoated substrate to form one or more ground coat layer(s), the ground coat composition(s) comprising at least one non-platelet-shaped titanium dioxide pigment (T);
b. applying on the thus formed only or last ground coat layer(s) at least one midcoat composition to form one or more midcoat layer(s), the midcoat composition(s) comprising at least one platelet-shaped titanium oxide pigment (P) selected from the group consisting of hydrogen titanium oxide (P1), titanium dioxide coated fluorinated mica (P2) and titanium dioxide coated aluminum (P3);
c. applying on the thus formed only or last midcoat layer(s) at least one clearcoat composition to form one or more clearcoat layer(s); and
d. curing the not yet cured or not yet fully cured ground coat layers, midcoat layers and/or clearcoat layers.

11. The method for producing a multilayer coating according to claim 10, wherein the midcoat composition comprises a film-forming polymer (A1), and in case the film-forming polymer (A1) is externally crosslinkable, a crosslinking agent (A2), and wherein
the weight ratio of the hydrogen titanium oxide (P1), if present, to the sum of film-forming polymers (A1) and crosslinkers (A2), is in a range from 0.01 to 0.5; and/or
the weight ratio of the platelet-shaped titanium dioxide coated fluorinated mica (P2), if present, to the sum of film-forming polymers (A1) and crosslinkers (A2), is in a range from 0.01 to 0.5; and/or
the weight ratio of the titanium dioxide coated aluminum pigment (P3), if present, to the sum of film-forming polymers (A1) and crosslinkers (A2) is in a range from 0.001 to 0.2.

12. A multilayer coated substrate comprising a multilayer coating according to claim 1, the substrate being an uncoated or precoated substrate selected from the group consisting of metal substrates, plastic substrates, glass, and textiles.

13. The multilayer coated substrate according to claim 12, the substrate being a precoated metal substrate comprising at least one of a primer coating layer, an electrodeposition coating layer and a conversion coating layer.

14. The multilayer coated substrate according to claim 12, being an automotive body or part thereof.
